(19) United States
(12) Patent Application Publication
(10) Pub. No.: US 2023/0122553 A1
(43) Pub. Date: Apr. 20, 2023

(54) METHOD AND APPARATUS FOR DRAWING A DRAWING USING STRUCTURAL INFERENCE OF OBJECTS IN THE DRAWING

(71) Applicant: ELECTRONICS AND TELECOMMUNICATIONS RESEARCH INSTITUTE, Daejeon (KR)

(72) Inventors: Seung Jae LEE, Daejeon (KR); Su Woong LEE, Daejeon (KR); Yong Sik LEE, Daejeon (KR); Ju Won LEE, Daejeon (KR); Da Un JUNG, Daejeon (KR); Jong Gook KO, Daejeon (KR); Won Young YOO, Daejeon (KR)

(21) Appl. No.: 17/591,445

(22) Filed: Feb. 2, 2022

(30) Foreign Application Priority Data
Oct. 20, 2021 (KR) 10-2021-0140496

(51) Int. Cl. G06F 30/13; G06F 30/12

(52) U.S. Cl. CPC G06F 30/13; G06F 30/12; G06F 2111/20

(57) ABSTRACT

The present invention relates to an apparatus and method for drawing, the method comprising: inputting a drawing image; recognizing a component in the input drawing image; inferring a structure of an object based on the recognized component; and drawing the inferred structure of the object.

### CROSS REFERENCE TO RELATED APPLICATION

The present application claims priority to a KR application 10-2021-0140496, filed Oct. 20, 2021, the entire contents of which are incorporated herein for all purposes by this reference.

### BACKGROUND OF THE INVENTION

### Field of the Invention

The present disclosure relates to a method and apparatus for drawing a drawing and, more particularly, to a method and apparatus for drawing a drawing by using structural inference of an object in the drawing.

### Description of the Related Art

An image drawing represents information on a drawing by using a bitmap in an image file, and a computer aided design (CAD) process is needed for actual design. In this regard, a process of connecting points and lines and recognizing components in an image drawing is indispensable. Generally, drawing an image drawing has been studied with the main focus on a process of capturing and vectorizing points and lines connected in an image file, and such a process partially includes a process of extracting drawing information by detecting an object in the image drawing. However, in practice, an image drawing is drawn mostly by utilizing assistant vectorization software rather than an automated means, or a person draws the image drawing again. As this process requires a lot of time and effort but has low reusability, it is inefficient.

Vectorization of an image drawing is studied to draw sketch images of designs and animations, and an overall structure is not captured nor understood since the main focus is on the representation and connection of lines. Deep learning-based vectorization is also being studied, but it requires a lot of operation time and does not include any step of understanding actual components. A method of learning and drawing connections and zones in a floor plan, which are to be used for rooms, an arrangement and construction of the floor plan, has been proposed. However, the method is limited to floor plans and is not suitable for using an object in which multiple components are connected. In recent years, new approaches are being studied which learn an order of drawing a drawing and reproduce the order in a component level. However, there are still only a few studies addressing a method of drawing a drawing itself.

The conventional technique utilizes a vectorization-based algorithm to draw a drawing, but users feel discomfort problems such as fragmentation of drawings, unknown internal parts like members, and necessity of manual drawing works.

### SUMMARY

The present disclosure is directed to provide a method and apparatus for drawing the structure of an object by recognizing a component in a drawing image and inferring the structure of the object based on the recognized component.

The present disclosure is directed to provide a drawing method and apparatus for searching a component library, when there is a component missing from an inferred structure of an object, to retrieve a similar component to the missing component, adding the retrieved component to the library and drawing the component.

Other objects and advantages of the present disclosure will become apparent from the description below and will be clearly understood through embodiments of the present disclosure. It is also to be easily understood that the objects and advantages of the present disclosure may be realized by means of the appended claims and a combination thereof.

According to an embodiment of the present invention, a method for identifying music in a content, includes: extracting and storing a fingerprint of an original audio in an audio fingerprint DB; extracting a first fingerprint of a first audio in the content; and searching for a fingerprint corresponding to the fingerprint of the first audio in the audio fingerprint DB, wherein the first audio is audio data in a music section detected from the content.

According to an embodiment of the present invention, a method for drawing, the method comprising: inputting a drawing image; recognizing a component in the input drawing image; inferring a structure of an object based on the recognized component; and drawing the inferred structure of the object.

According to an embodiment of the present invention, a method for drawing, the method, further comprising classifying the drawing image based on an attribute of a drawing.

According to an embodiment of the present invention, a method for drawing, the method, further comprising recognizing individually a component in the drawing image.

According to an embodiment of the present invention, a method for drawing, wherein the inferring of the structure of the object based on the recognized component comprises inferring the structure of the object in a direction from a lower component to an upper component.

According to an embodiment of the present invention, a method for drawing, wherein the inferring of the structure of the object based on the recognized component comprises inferring the structure of the object based on a first component image viewed from a first direction.

According to an embodiment of the present invention, a method for drawing, the method, further comprising inferring the structure of the object based on a second component image viewed from a second direction different from the first direction.

According to an embodiment of the present invention, a method for drawing, wherein a height of the first component image and a height of the second component image are identical.

According to an embodiment of the present invention, a method for drawing, wherein the drawing of the inferred structure of the object further comprises drawing the structure of the object by referring to inference result and a preset component library.

According to an embodiment of the present invention, a method for drawing, the method, further comprising: retrieving a component with similarity exceeding a preset value by referring to the component library, when there is a component missing from the structure of the object; and registering the retrieved component to the component library.

According to an embodiment of the present invention, a method for drawing, wherein the drawing of the inferred structure of the object comprises: modeling the structure of the object in three dimensions; and generating the structure of the object in a CAD file.

According to an embodiment of the present invention, an apparatus for drawing, the apparatus comprising: an input unit configured to receive an input of a drawing image; a controller configured to: recognize a component in the input drawing image, infer a structure of an object based on the recognized component, and draw the inferred structure of the object, and a display unit configured to display the structure of the object.

According to an embodiment of the present invention, an apparatus for drawing, wherein the controller is further configured to classify the drawing image based on an attribute of a drawing.

According to an embodiment of the present invention, an apparatus for drawing, wherein the controller is further configured to individually recognize a component in the input drawing image.

According to an embodiment of the present invention, an apparatus for drawing, wherein the controller is further configured to infer the structure of the object in a direction from a lower component to an upper component.

According to an embodiment of the present invention, an apparatus for drawing, wherein the controller is further configured to infer the structure of the object based on a first component image viewed from a first direction.

According to an embodiment of the present invention, an apparatus for drawing, wherein the controller is further configured to infer the structure of the object based on a second component image viewed from a second direction different from the first direction.

According to an embodiment of the present invention, an apparatus for drawing, wherein a height of the first component image and a height of the second component image are identical.

According to an embodiment of the present invention, an apparatus for drawing, the apparatus, further comprising a memory configured to a preset component library, wherein the controller is further configured to draw the structure of the object by referring to inference result and the preset component library.

According to an embodiment of the present invention, an apparatus for drawing, wherein the controller is further configured to: retrieve a component with similarity exceeding a preset value by the component library, when there is a component missing from the structure of the object, and register the retrieved component to the component library.

According to an embodiment of the present invention, an method for drawing, the method comprising: capturing, by a camera, a drawing image; recognizing a component in the captured drawing image; inferring a structure of an object based on the recognized component; and drawing the inferred structure of the object in a CAD file.

According to an embodiment of the present disclosure, as a component in a drawing image is recognized, the structure of an object is inferred based on the recognized component and the inferred structure of the object is drawn, a reusable drawing may be constructed, thereby enhancing a user's convenience.

As the present disclosure is directed to provide a drawing method and apparatus for searching a component library, when there is a component missing from an inferred structure of an object, to retrieve a similar component to the missing component, adding the retrieved component to the library and drawing the component, a component missing from a component recognition process may be added so that a drawing may keep updated to a higher quality.

Effects obtained in the present disclosure are not limited to the above-mentioned effects, and other effects not mentioned above may be clearly understood by those skilled in the art from the following description.

### BRIEF DESCRIPTION OF THE DRAWINGS

FIG. 1 is a view illustrating a configuration of a drawing apparatus according to an embodiment of the present disclosure.

FIG. 2 is a flowchart illustrating a drawing method according to an embodiment of the present disclosure.

FIG. 3 is a view illustrating a concept of a drawing method according to an embodiment of the present disclosure.

FIG. 4 is a view illustrating the recognition of a component and an object from an image drawing according to an embodiment of the present disclosure.

FIGS. 5A and 5B are views illustrating a representative drawing and a representative drawing recognition result according to an embodiment of the present disclosure.

FIGS. 6A and 6B are views illustrating a detailed drawing and a detailed drawing recognition result according to an embodiment of the present disclosure.

FIGS. 7A, 7B, and 7C are views illustrating a target object and a drawing image viewed from a different direction according to an embodiment of the present disclosure.

FIGS. 8A and 8B are views illustrating recognition of a component in an individual drawing image according to an embodiment of the present disclosure.

FIG. 9 is a view illustrating a structure of an object inferred based on a recognized component according to an embodiment of the present disclosure.

FIG. 10 is a view illustrating an embodiment of drawing a structure of an object based on an inference result according to an embodiment of the present disclosure.

FIG. 11 is a view illustrating an embodiment of a component library according to an embodiment of the present disclosure.

FIG. 12 is a view illustrating an embodiment of CAD drawing according to an embodiment of the present disclosure.

FIG. 13 is a view illustrating an embodiment of CAD drawing according to an embodiment of the present disclosure.

FIG. 13 is a view illustrating an embodiment of a component missing from a structure inference result according to another embodiment of the present disclosure.

FIG. 14 is a view illustrating a flowchart of a drawing method for a case in which there is a component missing from an inference result.

FIG. 15 is a view illustrating a flowchart of a drawing method according to another embodiment of the present disclosure.

FIG. 16 is a view illustrating a configuration of a drawing apparatus according to an embodiment of the present disclosure.

### DETAILED DESCRIPTION

Hereinafter, embodiments of the present disclosure will be described in detail with reference to the accompanying drawings so that those of ordinary skill in the art to which the present disclosure pertains can easily implement them. However, the present disclosure may be implemented in several different forms and is not limited to the embodiments described herein.

In describing an embodiment of the present disclosure, if it is determined that a detailed description of a well-known configuration or function may obscure the gist of the present disclosure, a detailed description thereof will be omitted. And, in the drawings, parts not related to the description of the present disclosure are omitted, and similar reference numerals are attached to similar parts.

In the present disclosure, the components that are distinguished from each other are for clearly explaining each characteristic, and the components do not necessarily mean that the components are separated. That is, a plurality of components may be integrated to form one hardware or software unit, or one component may be distributed to form a plurality of hardware or software units. Accordingly, even if not specifically mentioned, such integrated or distributed embodiments are also included in the scope of the present disclosure.

In the present disclosure, components described in various embodiments do not necessarily mean essential components, and some may be optional components. Accordingly, an embodiment composed of a subset of components described in an embodiment is also included in the scope of the present disclosure. In addition, embodiments including other components in addition to components described in various embodiments are also included in the scope of the present disclosure.

In the present disclosure, terms such as first, second, etc. are used only for the purpose of distinguishing one component from other components, and unless otherwise specified, the order or importance between the components is not limited. Accordingly, within the scope of the present disclosure, a first component in one embodiment may be referred to as a second component in another embodiment, and similarly, a second component in one embodiment is referred to as a first component in another embodiment.

When a component of the present disclosure is referred to as being “connected” or “connected” to another component, it may be directly connected or connected to the other component, but it should be understood that other components may exist in between. On the other hand, when it is said that a certain element is “directly connected” or “directly connected” to another element, it should be understood that there is no other element in the middle.

In addition, in the present disclosure, the description of each drawing may be applied to different drawings unless one drawing showing an embodiment of the present disclosure corresponds to another drawing and an alternative embodiment.

Hereinafter, the present disclosure will be described in more detail with reference to the drawings.

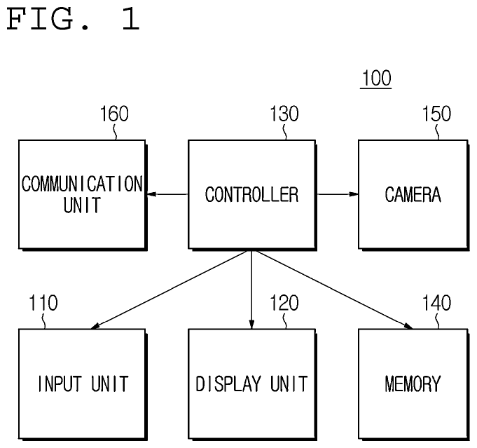

FIG. 1 is a view illustrating a configuration of a drawing apparatus according to an embodiment of the present disclosure.

Referring to FIG. 1, a drawing apparatus 100 includes an input unit 110, a display unit 120, a controller 130, a memory 140, a camera 150, and a communication unit 160.

The input unit 110 receives a drawing image as an input. Herein, the drawing image includes an old hand-drawing drawing or a scanned drawing for a traditional building. Extensions of the drawing image include jpg, tif, and pdf.

The display unit 120 displays a structure of an object according to a control command from the controller 130.

The controller 130 controls the input unit 110, the display unit 120, the memory 140, the camera 150, and the communication unit 160.

The controller 130 recognizes a component in the input drawing image, infers a structure of an object based on the recognized component, and draws a drawing of the inferred structure of the object. Herein, the object includes a traditional building and a modern building.

The controller 130 classifies the drawing image based on an attribute of the drawing.

An attribute of an individual drawing means a concrete feature of the drawing.

For example, an attribute of a drawing may be a representative drawing or a detailed drawing, depending on whether the drawing illustrates a whole or a part. In addition, an attribute of a drawing may be a front view, a side view, and a rear view according to directions in which an object is viewed.

The controller 130 recognizes individual components in the input drawing image.

The controller 130 infers the structure of the object in a direction from a lower component to an upper component. The controller 130 may infer the structure of the object in a direction from left to right.

The controller 130 infers the structure of the object based on a first component image viewed from a first direction.

The controller 130 infers the structure of the object based on a second component image viewed from a second direction different from the first direction. Herein, a height of the first component image and a height of the second component image are identical. In addition, the first component image and the second component image are the same component.

The controller 130 draws the structure of the object by referring to the inference result and the preset component library.

When there is a component missing from the structure of the object, the controller 130 retrieves a component, of which the similarity exceeds a preset value, by referring to the component library, and registers the retrieved component to the component library.

The memory 140 saves the preset component library.

The camera 150 captures a front image according to a control command from the controller 130.

The communication unit 160 transmits and receives data to and from an external server.

The controller 130 receives a component library from the external server via the communication unit, and when there is a missing component, the controller 130 retrieves a component, of which the similarity exceeds a preset value, by referring to the received component library, and registers the retrieved component to the component library. Herein, the similarity may be 90%. The similarity is not limited thereto but may have a variable value.

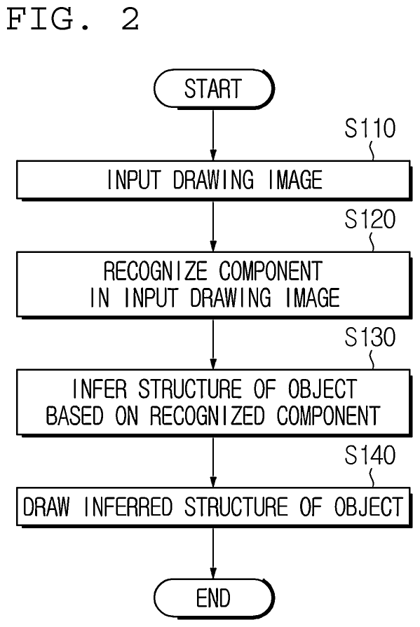

FIG. 2 is a flowchart illustrating a drawing method according to an embodiment of the present disclosure. The present invention is implemented by a drawing apparatus.

Referring to FIG. 2, a drawing image is input (S110).

A component in the input drawing image is recognized (S120). When there is a figure in the input drawing image, a figure of the recognized component is calculated, and the calculated figure of the component is stored in a memory.

Based on the recognized component, a structure of an object is inferred (S130).

The inferred structure of the object is drawn (S140).

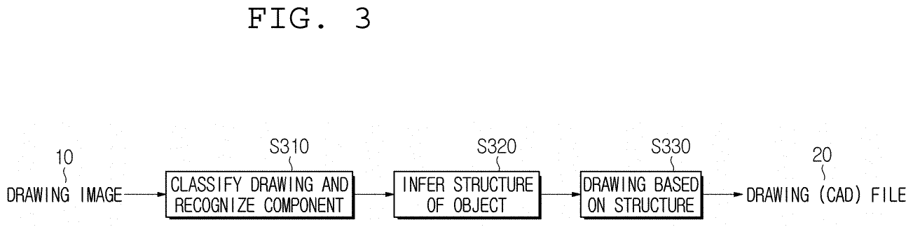

FIG. 3 is a view illustrating a concept of a drawing method according to an embodiment of the present disclosure.

Referring to FIG. 3, when a drawing image 10 is input, a drawing is classified based on the drawing image 10, and a component in the drawing image 10 is recognized (S310).

The drawing image 10 includes an old hand-drawing drawing or a scanned drawing for a traditional building. The extension of the drawing image 10 may be jpg, tif, pdf, png, and bmp.

When classifying the image and recognizing the component (S310), a type of the drawing and the component are recognized based on a drawing classification model and a component recognition model, which are pretrained for the drawing image 10.

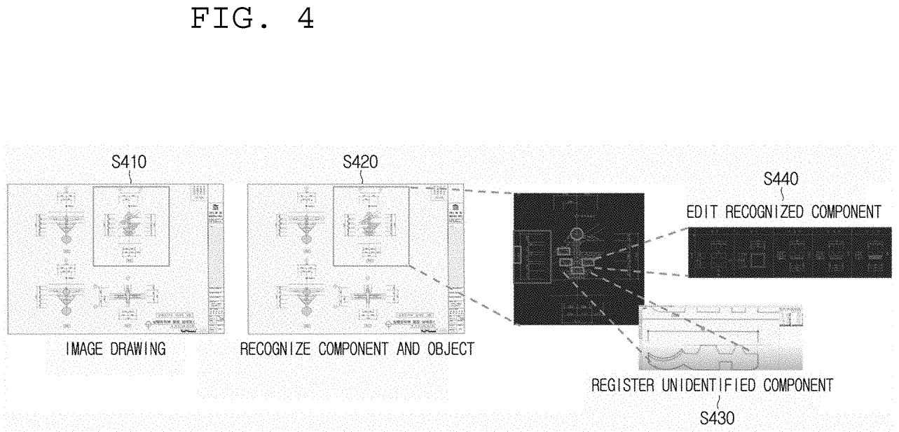

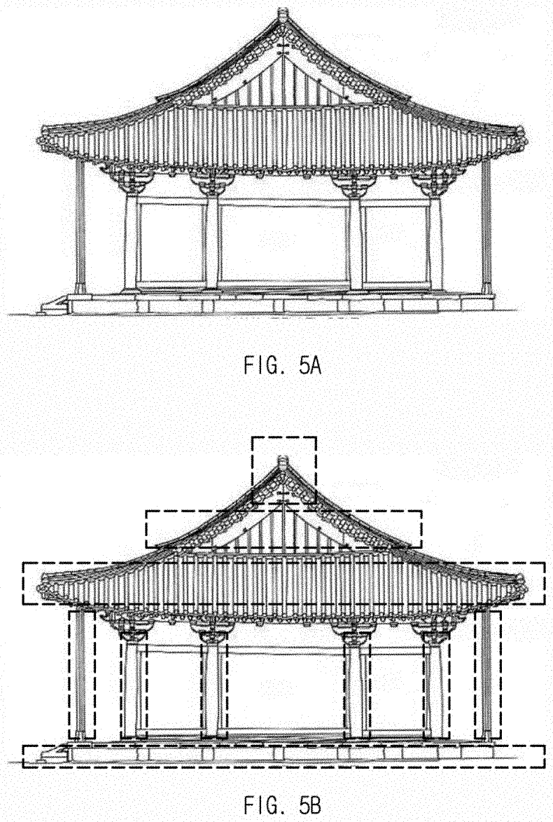

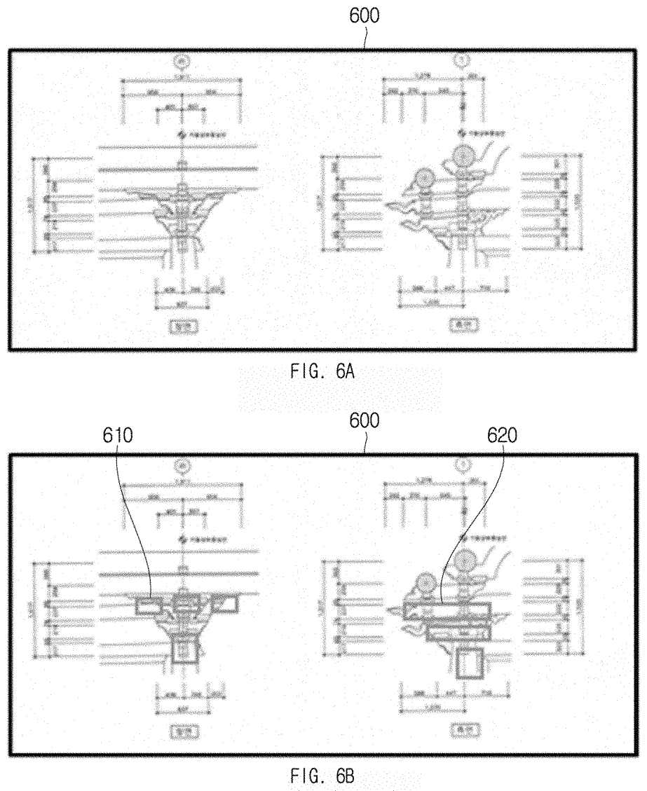

For example, referring to FIG. 5 and FIG. 6, in the case of an architectural drawing, for a representative drawing, a type of the drawing and a constitutional part are recognized, and for a detailed drawing, a type of a constitutional part and a component are recognized.

Based on artificial intelligence, the drawing is classified and a component is recognized, and then a result is provided as an input of inference for a structure of an object.

Based on the classified drawing and the recognized component, the structure of the object is inferred (S320).

Specifically, a recognition result may be expressed as a recognition result of the type of drawing and the component and as a recognition result of the constitutional part and may be utilized as an input value for drawing based on the structure through structure inference (S320).

The structure of the object is inferred based on a type of a component and a position of the component.

In addition, the structure of the object may be inferred in comparison with an object structure model which is trained for a structure of an existing traditional building. In this case, a difference may occur between the inference result and the drawing image.

Drawing is performed based on the structure of the object (S330). Specifically, the structure of the object in the drawing is drawn using a template of the structure.

A drawing file 20 is generated by performing drawing. Herein, the drawing file includes a CAD file. The file extension becomes dwg. The file extension is not limited to dwg, and the drawing file capable of executing CAD is generated. In addition, the generated drawing file 20 is a file capable of dimension and name editing for drawing.

A component is drawn using a preset component library, and when there is a component that fails to be recognized during the drawing process, a most similar component may be retrieved by searching the component library and be added to the component library.

FIG. 4 is a view illustrating the recognition of a component and an object from an image drawing according to an embodiment of the present disclosure.

Referring to FIG. 4, an image drawing is input (S410). Based on the input image drawing, a component and an object, which are included in the image drawing, are recognized (S420). When the image drawing includes a figure, the figures of the recognized component and object are calculated based on the figure, and the figures thus calculated are stored in a memory.

When at least one of a missing component and an unidentified component exists in the recognized components, it is retrieved and registered (S430).

Specifically, when there is a missing component among the recognized components, a component is retrieved in a preset component library, of which the similarity to the missing component exceeds a threshold. The retrieved component is registered to the component library.

The recognized components are edited (S440).

When a recognized component is made of wood, distortion may Occur. In this case, if it is recognized as it is, drawing may not be smoothly performed. In this case, a figure of the recognized component is corrected and edited by considering the recognized component and a structure of an object.

FIG. 5 is a view illustrating a representative drawing and a representative drawing recognition result according to an embodiment of the present disclosure. FIG. 5 includes FIG. 5(a) and FIG. 5(b).

FIG. 5(a) is a view illustrating a representative drawing. FIG. 5(b) is a view illustrating a representative drawing recognition result.

Referring to FIG. 5(a), a drawing image may be a representative drawing that representatively expresses a structure of an object. For example, when an object 500 is a traditional building, a front view of the traditional building may be a representative drawing.

Referring to FIG. 5(b), a representative drawing recognition result may be a drawing that illustrates a recognition result of a plurality of components included in a representative drawing. For example, when the object 500 is a traditional building, a drawing recognition result may recognize a plurality of components 510 in the traditional building and display the components 510 in a drawing image.

FIG. 6 is a view illustrating a detailed drawing and a detailed drawing recognition result according to an embodiment of the present disclosure. FIG. 6 includes FIG. 6(a) and FIG. 6(b).

FIG. 6(a) is a view illustrating a detailed drawing. FIG. 6(b) is a view illustrating a detailed drawing recognition result.

Referring to FIG. 6(a), a drawing image may be a detailed drawing that expresses a structure of an object in detail. For example, when an object 600 is a traditional building, a drawing illustrating a specific component called gongpo of the traditional building may be a detailed drawing.

Referring to FIG. 6(b), a detailed drawing recognition result may be a drawing that illustrates a recognition result of a plurality of components included in a detailed drawing. For example, when the object 600 is a traditional building, a drawing recognition result may recognize a plurality of components 610 and 620 included in a specific component called gongpo of the traditional building and display the components 610 and 620 in a drawing image.

When the image drawing includes a figure, the figures of the recognized component and object are calculated based on the figure, and the figures thus calculated are stored in a memory. In addition, the calculated figures may be marked for respective components.

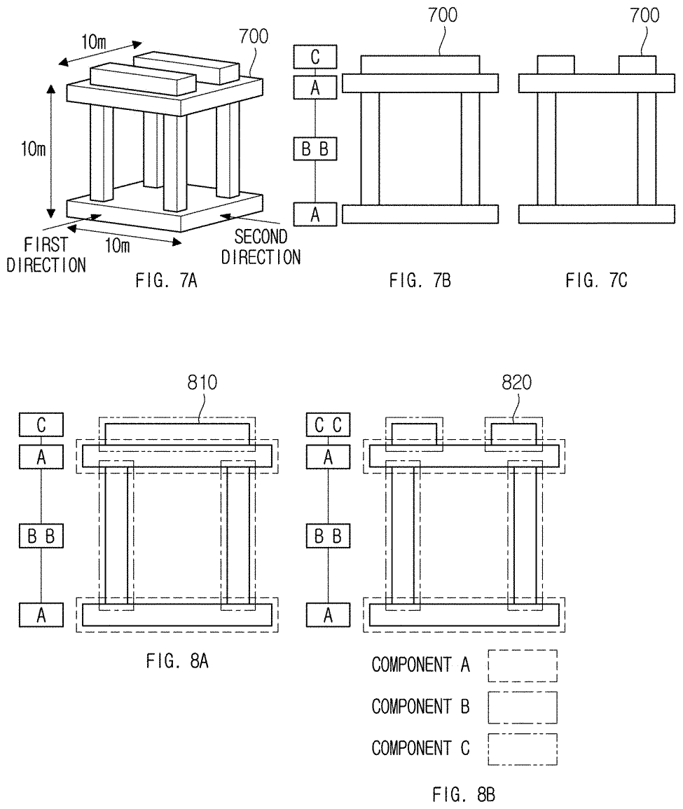

FIG. 7 is a view illustrating a target object and a drawing image viewed from a different direction according to an embodiment of the present disclosure. FIG. 7 includes FIG. 7(a), FIG. 7(b), and FIG. 7(c).

FIG. 7(a) is a view illustrating a target object. FIG. 7(b) is a view illustrating a drawing image in which a target object is viewed from a first direction. FIG. 7(c) is a view illustrating a drawing image in which a target object is viewed from a second direction.

Referring to FIG. 7(a), a target object 700 may be configured as a structure consisting of 3 components of A, B and C.

Referring to FIG. 7(b), a first drawing image, in which the target object 700 is viewed from the first direction, may be a front view.

Referring to FIG. 7(c), a second drawing image, in which the target object 700 is viewed from the second direction, may be a side view.

For example, by recognizing the first drawing image and the second drawing image, a type of a drawing and a component may be recognized.

Hereinafter will be described a case in which an image drawing includes a figure.

An image drawing may include a figure and be utilized based on the figure.

As there is scale information in a drawing, a value may be read, and a scale may be known as in a map.

In case of object recognition, when an overall size of an input image is assumed to be 1, a type of the object, a center coordinate (x, y), and width and height (d, h) may be known through recognition. By using such information, a type of a traditional building member and a relative position in a drawing may be obtained.

As the relative positions of A, B and C may be obtained based on the relative position, an order of assembly may be inferred.

Accordingly, a figure of an actual drawing may be used, and an order of assembly may be inferred based on a recognized result. However, as shown in the embodiment of FIG. 13, a figure of a drawing may be different from an actual figure (like in most traditional architectural drawings), an order of assembly may be grasped after recognition and a model may be uploaded like in the example of the present invention so that the figure may be embodied in a semi-automatic way. When a recognition result shows that a figure is not suitable for 3D modeling, a partial correction of figure may be performed.

When the image drawing includes a figure, the figures of the recognized component and object are calculated based on the figure, and the figures thus calculated are stored in a memory. In addition, the calculated figures may be marked for respective components. A controller may calculate a figure of an object first and then calculate a figure of an individual component based on the sizes and positions of the object and the individual common ent.

For example, when an image drawing includes a horizontal length of 10 m, a vertical length of 10 m, and a height of 10 m, the figures of the object 700 become a horizontal length of 10 m, a vertical length of 10 m, and a height of 10 m.

Referring to FIG. 7(b) and FIG. 7(c), when the components are A, B and C, the figures of the components A, B and C are individually calculated and stored in a memory.

In the case of the component A, the horizontal length is 10 m, the vertical length is 10 m, and the height is 1 m.

In the case of the component B, the horizontal length is 1 m, the vertical length is 1 m, and the height is 7 m.

In the case of the component C, the horizontal length is 8 m, the vertical length is 1 m, and the height is 7 m.

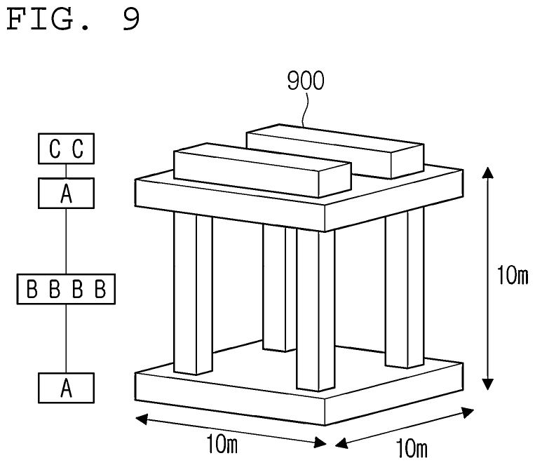

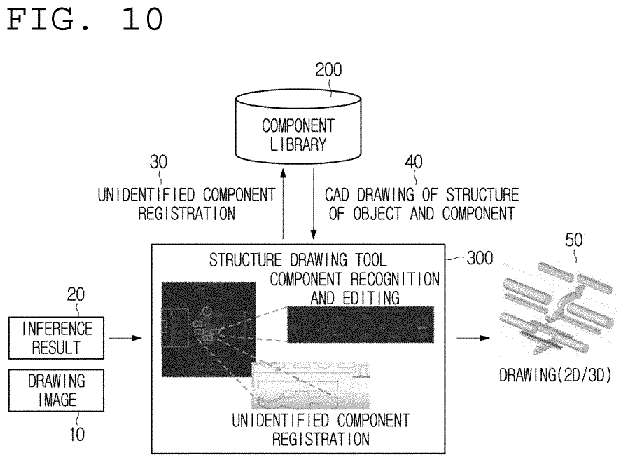

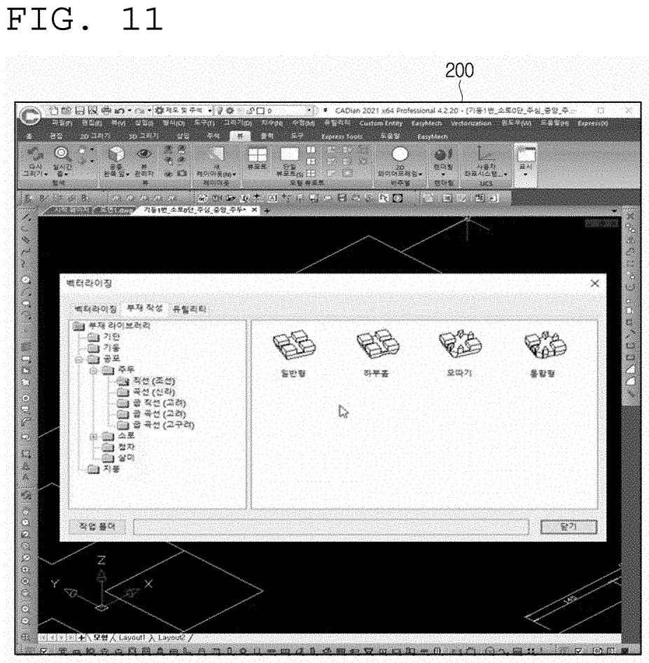

FIG. 8 is a view illustrating recognition of a component in an individual drawing image according to an embodiment of the present disclosure. FIG. 8 includes FIG. 8(a) and FIG. 8(b).

FIG. 8(a) is a view illustrating component recognition in a first drawing image 810. FIG. 8(b) is a view illustrating component recognition in a second drawing image 820.

Referring to FIG. 8(a), when there are 3 components of A, B and C, a component recognition result, which utilizes position information, may be [A]-[B, B]-[A]-[C] for the first drawing image 810 in the directions from bottom to top and left to right. Herein, the first drawing image 810 may be a front view.

That is, in the case of a front view, when it is assumed that components are cumulatively piled in the direction from bottom to top, a component constituting a first step is A, components constituting a second step are B and B, a component constituting a third step is A, and a component constituting a fourth step is C.

Referring to FIG. 8(b), [A]-[B, B]-[A]-[C, C] may be expressed for the second drawing image 820. Herein, the second drawing image 820 may be a side view.

That is, in the case of a side view, when it is assumed that components are cumulatively piled in the direction from bottom to top, a component constituting a first step is A, components constituting a second step are B and B, a component constituting a third step is A, and components constituting a fourth step are C and C.

Here, the square bracket “[ ]” means a component at a same height, and the connection mark “-” means a connection to a component at a next height.

Based on this scheme of representation, a maximum number of components allowed for each step may be inferred by considering a common component between the first drawing image and the second drawing image.

In the first step, a maximum number of constitutive components is one A.

In the second step, a maximum number of constitutive components is four Bs.

In the third step, a maximum number of constitutive components is one A.

In the fourth step, a maximum number of constitutive components is two Cs.

When there is a common component between a front view and a side view, the same component may be identified by distinguishing and learning recognition units between the front and side of the component during the drawing classification and component recognition step.

First, it is checked whether or not there is a same component, a maximum number of components is inferred for each square bracket, and a structure is inferred by inputting the maximum number into a pretrained structure inference model.

A structure of an object is inferred by referring to an inference result and a preset component library. Herein, the component library includes a plurality of existing building structures.

Next, for a component recognized in a first drawing image and a second drawing image, a connection relation is inferred by using position information.

The connection relation means a connection between a most similar component to a model, which is trained beforehand according to a form of an object, and the remaining components.

For example, when the object is a traditional building, a gongpo type is identified based on the position and number of soros, and a structure of the object is inferred.

For detailed inference of structure, a most similar structure is searched by referring to an existing building corresponding to the pretrained model, and the structure of the object is inferred based on the most similar structure.

FIG. 9 is a view illustrating a structure of an object inferred based on a recognized component according to an embodiment of the present disclosure.

Referring to FIG. 9, a structure of an object 900, which is inferred based on a recognized component, is [A]-[B, B, B, B]-[A]-[C, C] in the direction from bottom to top.

Next, inference model learning will be described.

In inference model learning, a structure for whole assembly is given as an answer, and an object inference result is an input.

For example, an answer is [A]-[B, B, B, B]-[A]-[C, C], [A]-[B, B]-[A]-[C] viewed from a first direction is input as an object inference result, [A]-[B, B]-[A]-[C, C] viewed from a second direction is input, and thus learning is performed to infer the whole structure.

Such data may be considered as time series data, and learning of the data may be performed by such a method as RNN and LSTM. In the case of a complicated object like a building, as a whole structure is difficult to configure in a single drawing, an object may be divided into a plurality of parts, and the structure of the object may be inferred by individually inferring each of multiple objects.

When the image drawing includes a figure, the figures of the recognized component and object are calculated based on the figure, and the figures thus calculated are stored in a memory. In addition, the calculated figures may be marked for respective components.

Referring to FIG. 9, the figures of the inferred object 900 become a horizontal length of 10 m, a vertical length of 10 m, and a height of 10 m.

In addition, when the object includes components A, B and C, the figures of the components A, B and C are individually calculated and stored in a memory.

In the case of the component A, the horizontal length is 10 m, the vertical length is 10 m, and the height is 1 m.

In the case of the component B, the horizontal length is 1 m, the vertical length is 1 m, and the height is 7 m.

In the case of the component C, the horizontal length is 8 m, the vertical length is 1 m, and the height is 7 m.

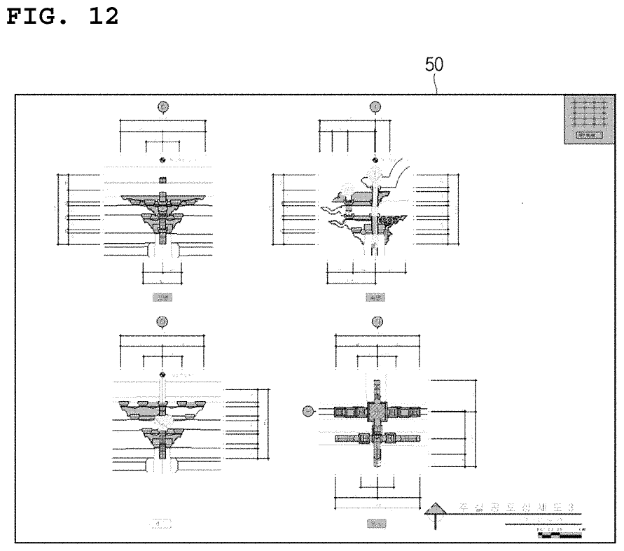

FIG. 10 is a view illustrating an embodiment of drawing a structure of an object based on an inference result according to an embodiment of the present disclosure.

Referring to FIG. 10, a structure-based drawing step is needed to draw an inferred structure.

In order to implement the structure-based drawing step, a structure drawing tool 300 and a component library 200 are required.

The structure drawing tool 300 checks a recognized component based on a drawing image 10 and an inference result 20 and proceeds drawing 50 of an object based on a result of the component library 200. The structure drawing tool 300 registers an identified component and performs component recognition and editing.

The component library 200 includes a structure of an object, which constitutes the drawing image 10, a procedure of constructing the object, a structure template including structures of multiple objects, and a component for drawing. A memory stores the component library 200.

An overall process performs drawing 50 for the inference result 20, the drawing image 10 and the recognized component through the preconfigured component library 200 and the structure template.

First, the inference result 20 and the drawing image 10 are input, and a structure of an object, which is most similar to an inferred structure of the object, and a recognized component are obtained from the component library 200. When necessary, the dimension and name of the recognized component may be edited for drawing.

When there is a missing component from the inference result 20, a process 30 of registering an unidentified component is implemented.

The component library 200 forwards the structure of the object and a component CAD drawing 40 to the structure drawing tool 300.

When a specific component is not present in the component library 200, a user makes a drawing including the specific component, and a drawing image received from the user is added to the component library 200. The added drawing image is registered to the component library 200. The structure drawing tool 300 constructs an overall drawing by updating the added component drawing.

By proceeding the drawing 50, the structure drawing tool 300 models the structure of the object in two dimensions and in three dimension and generates the structure of the object in a CAD file.

According to an embodiment, when there is a component missing from the inference result, the controller 130 receives a new component library from an external server via a communication unit.

A component, of which the similarity exceeds a preset value, is retrieved by referring to the received component library, and the retrieved component is registered to the component library. Herein, the similarity may be 90%. The similarity is not limited thereto but may have a variable value.

According to the present invention, when there is a missing component, a similar component is retrieved in an existing component library or a user inputs a new drawing image including the component so that the component library may keep updated and a sustainable and available system may be constructed.

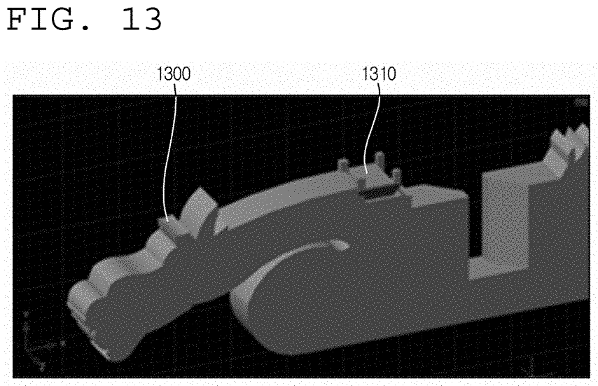

FIG. 11 is a view illustrating an embodiment of a component library according to an embodiment of the present disclosure.

Referring to FIG. 11, the component library 200 includes vectorizing, member writing, and utility.

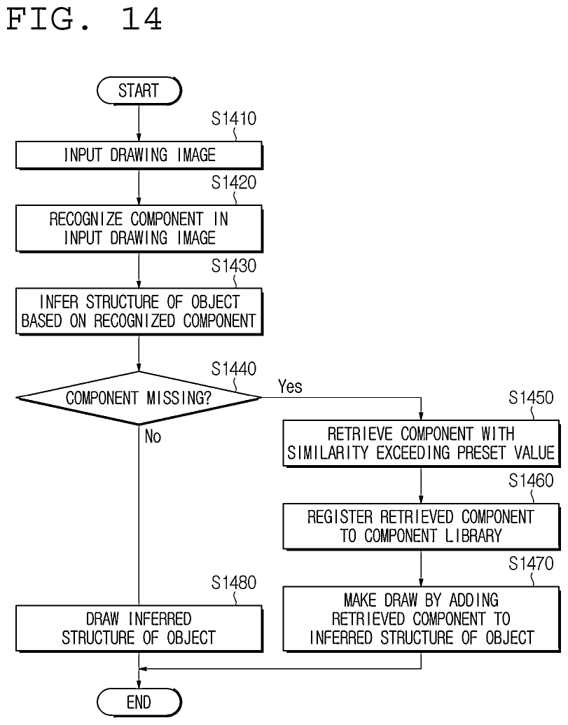

FIG. 12 is a view illustrating an embodiment of CAD drawing according to an embodiment of the present disclosure.

Referring to FIG. 12, when CAD drawing is performed, an image drawing is transformed to a CAD drawing 50. For a traditional building, individual components are recognized and made into the CAD drawing 50 capable of assembling the components again. A file format may be dwg. In addition, the file format is not limited to dwg, and conversion to a file capable of making a drawing is possible.

Specifically, for CAD drawing, a building classification engine is used to infer a structure of an object. In addition, based on a structure inference result, drawing is performed using a structure template of the object and a structure inference engine of the object, and for a component failing to be recognized, a most similar component is retrieved by referring to a component library and is registered to the component library.

FIG. 13 is a view illustrating an embodiment of a component missing from a structure inference result according to another embodiment of the present disclosure.

Referring to FIG. 13, the embodiment is a case in which there is a component 1310 missing from a structure 1300 of an object derived as a structure inference result. Alternatively, there may be a case in which the part 1310 cannot be assembled because the figures are different from those of the drawings.

Especially, in the case of a cultural asset like a traditional building, as it is a building, the internal condition is difficult to know before the building is dissembled for maintenance, and there is a component 1310 not viewed from outside or partially covered in the structure 1300 of the object.

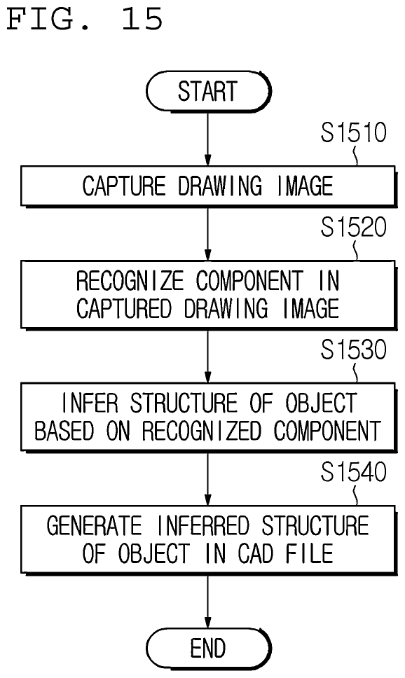

FIG. 14 is a view illustrating a flowchart of a drawing method for a case in which there is a component missing from an inference result. The present invention is implemented by a drawing apparatus 100.

Referring to FIG. 14, a drawing image is input (S1410). A component in the input drawing image is recognized (S1420). Based on the recognized component, a structure of an object is inferred (S1430).

Based on an inference result, there is a missing component (S1440), a component, of which the similarity exceeds a preset value, is retrieved by referring to a component library (S1450).

The retrieved component is registered to the component library (S1460).

Drawing is made by adding the retrieved component to the structure of the object (S1470).

Based on the inference result, when there is no missing component (S1440), the inferred structure of the object is drawn (S1480).

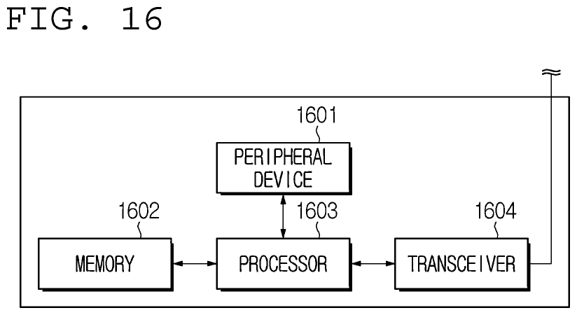

FIG. 15 is a view illustrating a flowchart of a drawing method according to another embodiment of the present disclosure. The present invention is implemented by a drawing apparatus.

A drawing image is captured by a camera (S1510).

A component in the captured drawing image is recognized (S1520). Based on the recognized component, a structure of an object is inferred (S1530).

The inferred structure of the object is generated in a CAD file (S1540).

Herein, the CAD file means a file with extension of dwg.

According to the present invention, as a drawing image is captured by a camera and is input, a user's convenience may be improved.

Hereinafter, the market size of architectural services will be described.

The market size of architectural services is about 9.2368 trillion KW(Korean Won) in 2018. The Architecture & Urban Research Institute (AURI) inversely estimated the market size by applying the construction cost rate of 4% in 2018.

The average added value inducement coefficient of the whole industry is 0.764, and the added value inducement coefficient of the architectural service is 0.89, which is higher than the average value of the whole industry.

FIG. 16 is a diagram illustrating a configuration of a drawing apparatus according to an embodiment of the present disclosure.

Referring to FIG. 16, the drawing apparatus includes a device 1600. The device 1600 may include a memory 1602, a processor 1603, a transceiver 1604, and a peripheral device 1601. Also, as an example, the device 1600 may further include other components, and is not limited to the above-described embodiment. In this case, as an example, the device may be an apparatus operating based on the above-described drawing apparatus.

More specifically, the device 1600 of FIG. 16 may be an imaging device and an exemplary hardware/software architecture. In this case, as an example, the memory 1602 may be a non-removable memory or a removable memory. Also, as an example, the peripheral device 1601 may include a display, GPS, or other peripheral devices, and is not limited to the above-described embodiment.

Also, as an example, the above-described device 1600 may include a communication circuit like the transceiver 1604, and may communicate with an external device based thereon.

Also, as an example, the processor 1603 may be a general-purpose processor, a digital signal processor (DSP), a DSP core, a controller, a microcontroller, an ASICs (Application Specific Integrated Circuits), an FPGA (Field Programmable Gate Array) circuits, any other It may be at least one or more of a tangible integrated circuit (IC) and one or more microprocessors associated with a state machine. That is, it may be a hardware/software configuration that performs a control role for controlling the above-described device 1600.

At this time, the processor 1603 may execute computer-executable instructions stored in the memory 1602 to perform various essential functions of the node. For example, the processor 1603 may control at least one of signal coding, data processing, power control, input/output processing, and communication operations. Also, the processor 1603 may control a physical layer, a MAC layer, and an application layer. Also, as an example, the processor 1603 may perform authentication and security procedures at an access layer and/or an application layer, and the like, and is not limited to the above-described embodiment.

For example, the processor 1603 may communicate with other devices through the transceiver 1604. As an example, the processor 1603 may control a node to communicate with other nodes through a network through execution of computer-executable instructions. That is, communication performed in the present invention can be controlled. As an example, other nodes may be NDN servers, content routers and other devices. For example, the transceiver 1604 may transmit an RF signal through an antenna, and may transmit the signal based on various communication networks.

In addition, as an example, MIMO technology, beamforming, etc. may be applied as the antenna technology, and the embodiment is not limited thereto. In addition, the signal transmitted and received through the transceiver 1604 may be modulated and demodulated to be controlled by the processor 1603, and the embodiment is not limited thereto.

The various embodiments of the present disclosure do not list all possible combinations, but are intended to illustrate representative aspects of the present disclosure, matters described in various embodiments may be applied independently or in combination of two or more. In addition, various embodiments of the present disclosure may be implemented by hardware, firmware, software, or a combination thereof. For implementation by hardware, one or more application specific Integrated Circuits (ASICs), Digital Signal Processors (DSPs), Digital Signal Processing Devices (DSPDs), Programmable Logic Devices (PLDs), Field Programmable Gate Arrays (FPGAs), general processor, a controller, a microcontroller, a microprocessor, and the like. For example, it may take various forms including the general-purpose processor. It is apparent that hardware may be disclosed in combination of one or more.

The scope of the present disclosure includes software or machine-executable instructions (eg, operating system, application, firmware, program, etc.) that cause an operation according to the method of various embodiments to be executed on a device or computer, and such software or and non-transitory computer-readable media in which instructions and the like are stored and executed on a device or computer.

The present disclosure described above can be various substitutions, modifications and changes within the scope that does not depart from the technical spirit of the present disclosure for those of ordinary skill in the art to which the present disclosure pertains, so the scope of the present disclosure is It is not limited by one embodiment and the accompanying drawings.

What is claimed is:

1. A method for drawing, the method comprising:
inputting a drawing image;
recognizing a component in the input drawing image;
inferring a structure of an object based on the recognized component; and
drawing the inferred structure of the object.

2. The method of claim 1, further comprising classifying the drawing image based on an attribute of a drawing.

3. The method of claim 1, further comprising recognizing individually a component in the drawing image.

4. The method of claim 1, wherein the inferring of the structure of the object based on the recognized component comprises inferring the structure of the object in a direction from a lower component to an upper component.

5. The method of claim 1, wherein the inferring of the structure of the object based on the recognized component comprises inferring the structure of the object based on a first component image viewed from a first direction.

6. The method of claim 5, further comprising inferring the structure of the object based on a second component image viewed from a second direction different from the first direction.

7. The method of claim 6, wherein a height of the first component image and a height of the second component image are identical.

8. The method of claim 1, wherein the drawing of the inferred structure of the object further comprises drawing the structure of the object by referring to inference result and a preset component library.

9. The method of claim 8, further comprising:
retrieving a component with similarity exceeding a preset value by referring to the component library, when there is a component missing from the structure of the object; and
registering the retrieved component to the component library.

10. The method of claim 1, wherein the drawing of the inferred structure of the object comprises:
modeling the structure of the object in three dimensions; and
generating the structure of the object in a CAD file.

11. An apparatus for drawing, the apparatus comprising:
an input unit configured to receive an input of a drawing image;
a controller configured to:
recognize a component in the input drawing image,
infer a structure of an object based on the recognized component, and
draw the inferred structure of the object, and
a display unit configured to display the structure of the object.

12. The apparatus of claim 11, wherein the controller is further configured to classify the drawing image based on an attribute of a drawing.

13. The apparatus of claim 11, wherein the controller is further configured to individually recognize a component in the input drawing image.

14. The apparatus of claim 11, wherein the controller is further configured to infer the structure of the object in a direction from a lower component to an upper component.

15. The apparatus of claim 11, wherein the controller is further configured to infer the structure of the object based on a first component image viewed from a first direction.

16. The apparatus of claim 15, wherein the controller is further configured to infer the structure of the object based on a second component image viewed from a second direction different from the first direction.

17. The apparatus of claim 16, wherein a height of the first component image and a height of the second component image are identical.

18. The apparatus of claim 11, further comprising a memory configured to a preset component library,
wherein the controller is further configured to draw the structure of the object by referring to inference result and the preset component library.

19. The apparatus of claim 18, wherein the controller is further configured to:
retrieve a component with similarity exceeding a preset value by the component library, when there is a component missing from the structure of the object, and
register the retrieved component to the component library.

20. A method for drawing, the method comprising:
capturing, by a camera, a drawing image;
recognizing a component in the captured drawing image;
inferring a structure of an object based on the recognized component; and
drawing the inferred structure of the object in a CAD file.
